(19) United States
(12) Patent Application Publication
(10) Pub. No.: US 2014/0365242 A1
(43) Pub. Date: Dec. 11, 2014

(54) Integration of Multiple Input Data Streams to Create Structured Data

(71) Applicant: Siemens Medical Solutions USA, Inc., Malvern, PA (US)

(72) Inventor: Robert A Neff, Villanova, PA (US)

(73) Assignee: Siemens Medical Solutions USA, Inc., Malvern, PA (US)

(21) Appl. No.: 14/220,171

(22) Filed: Mar. 20, 2014

Related U.S. Application Data
(60) Provisional application No. 61/832,173, filed on Jun. 7, 2013.

(51) Int. Cl. G06F 19/00; G06F 17/30

(52) U.S. Cl. CPC G06F 19/322; G06F 17/30289
USPC 705/3; 707/756

(57) ABSTRACT

Disclosed herein is a framework for integrating multiple input data streams. In accordance with one aspect, multiple input data streams are acquired from one or more pervasive devices during performance of a regular task. The acquired input data may be translated into structured data. One or more determinations may then be made based on the structured data.

### CROSS-REFERENCE TO RELATED APPLICATION

This application claims the benefit of U.S. provisional application No. 61/832,173 (Attorney Docket No. 2013P09797US) filed Jun. 7, 2013, the entire contents of which are incorporated herein by reference.

### TECHNICAL FIELD

The present disclosure generally relates to systems and methods for integrating multiple input data streams to create structured data.

### BACKGROUND

Information Technology Systems (e.g., Electronic Health Record (EHR), Computerized Physician Order Entry (CPOE), etc.) continue to play a significant role in cost reduction, quality measurement and improvement for healthcare. Medical records are now used, not only as a comprehensive record of healthcare, but also as a source of data for clinical decision support, hospital service activity reporting, monitoring hospitals' performance and for audit and research. The constant drive to improve the quality and safety of medical practice and hospital services and the increasing expectations and costs of medical care means the structure and content of the clinical record is becoming ever more important.

Patient's medical data in electronic health records (EHR) may be “unstructured” or “structured”. Unstructured data is information that cannot be organized into a database structure with data fields. The content of unstructured data cannot easily be read, analyzed or searched by a machine. Unstructured data may include, free text notes, such as a healthcare provider's (e.g., doctor, nurse, etc.) notes, waveforms, light images, MR (magnetic resonance) images and CT (computerized tomography) scans, scanned images of paper documents, video (including real-time or recorded video), audio (including real-time or recorded speech), ASCII text strings, image information in DICOM (Digital Imaging and Communication in Medicine) format, genomics and proteomics and text documents partitioned based on domain knowledge. It may also include medical history and physical examination documents, discharge summaries, ED Records, etc.

Structured data is in a form where the information can be easily manipulated to generate different reports and can easily be searched. Structured data has an enforced composition of different types of data (or data fields) in a database structure, and this allows for querying and reporting against the data types. Structured data may include health information stored in “organized” formats, such as charts and tables. It may include patient information organized in pre-defined fields, as well as clinical, financial and laboratory databases. An electronic medical record having information in a structured format is shown and described in, for example, U.S. Pat. No. 7,181,375, which is herein incorporated by reference in its entirety.

It is often more beneficial to have data in a structured and possibly coded format. Structured clinical data captured from healthcare providers is critical in order to fully realize the potential of health information technology systems. This is largely because structured clinical data can be manipulated, read, understood, analyzed, etc., more easily, by a computer or human, than unstructured data. Further, if medical records are not organized and complete, it can lead to frustration and possibly, misinformation.

Current methods for capturing and/or creating structured clinical data require significant effort and time with associated costs. Such methods include direct manual entry of information into structured data fields in, for example, a table. This is laborious and often impractical. Another method may be a dictation system, where a healthcare provider, for example, speaks into a dictation machine that outputs the text, often, as free text or where unstructured data is converted to structured data using optical character recognition or mark sense forms. Yet another method is to use keyword and template based documentation systems that try to optimize between structured inputs and freeform entry. Historically, these methods have not proven to be extremely effective and result in limited user satisfaction.

Even where unstructured data can quickly and accurately be converted to structured data, there are inefficiencies in obtaining the unstructured and structured data in the first place. For example, before, during or after a healthcare provider examines or interacts with a patient, he or she may need to manually type or otherwise enter data into a database. Or, the provider may need to dictate notes into a dictation machine; this free-text output is then converted to structured data. Or, a provider may need to enter data characterizing an image into a system. These additional steps to create and/or record structured and unstructured data for the patient record require extra time and effort by the healthcare provider and his or her staff.

### SUMMARY

The present disclosure relates to a framework for integrating multiple input data streams. In accordance with one aspect, multiple input data streams are acquired from one or more pervasive devices during performance of a regular task. The acquired input data may be translated into structured data. One or more determinations may then be made based on the structured data.

In accordance with another aspect, input sensor data is received from a wearable sensor and display worn by a healthcare provider during a patient encounter. The input sensor data may be translated into structured data. Based on such structured data, feedback information may be provided in association with one or more steps undertaken in the healthcare workflow. The feedback information may be provided to the wearable sensor and display for presentation.

This summary is provided to introduce a selection of concepts in a simplified form that are further described below in the following detailed description. It is not intended to identify features or essential features of the claimed subject matter, nor is it intended that it be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings. Furthermore, it should be noted that the same numbers are used throughout the drawings to reference like elements and features.

FIG. 1 shows an exemplary architecture;

FIG. 2 is a flow diagram illustrating an exemplary method of integrating multiple data streams;

FIG. 3 illustrates an exemplary method for facilitating a medication administration workflow;

FIG. 4 illustrates an exemplary method for automatically associating one or more healthcare devices with a particular patient;

FIG. 5 illustrates an exemplary method for facilitating labeling of items collected from a patient in a healthcare setting; and

FIG. 6 illustrates an exemplary method for facilitating patient privacy protection.

### DETAILED DESCRIPTION

In the following description, numerous specific details are set forth such as examples of specific components, devices, methods, etc., in order to provide a thorough understanding of embodiments of the present invention. It will be apparent, however, to one skilled in the art that these specific details need not be employed to practice embodiments of the present invention. In other instances, well-known materials or methods have not been described in detail in order to avoid unnecessarily obscuring embodiments of the present invention. While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It is to be understood that the present invention may be implemented in various forms of hardware, software, firmware, special purpose processors, or a combination thereof. Preferably, the present invention is implemented in software as a program tangibly embodied on a program storage device. The program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the program (or combination thereof) which is executed via the operating system. In addition, various other peripheral devices may be connected to the computer platform such as an additional data storage device and a printing device. If written in a programming language conforming to a recognized standard, sequences of instructions designed to implement the methods can be compiled for execution on a variety of hardware platforms and for interface to a variety of operating systems. In addition, embodiments of the present framework are not described with reference to any particular programming language. It will be appreciated that a variety of programming languages may be used to implement embodiments of the present invention.

It is to be further understood that since at least a portion of the constituent system modules and method steps depicted in the accompanying Figures may be implemented in software, the actual connections between the system components (or the flow of the process steps) may differ depending upon the manner in which the present invention is programmed. Given the teachings herein, one of ordinary skill in the related art will be able to contemplate these and similar implementations or configurations of the present invention.

The present disclosure generally describes a framework (e.g., system) that facilitates integration of multiple input data streams to create structured data. In accordance with one aspect, the present framework substantially continuously and unobtrusively captures information as it is produced during the “normal course of business”. Multiple streams of unstructured or semi-structured input data may be acquired by one or more networked pervasive devices, such as position sensors, measurement devices, audio sensors, video sensors, motion sensors, cameras, wearable sensors with integrated displays, healthcare instruments and so forth. Input data may also be automatically collected by a data miner from one or more external data sources. Such captured information is assimilated by, for example, automatically transforming the unstructured or semi-structured data (e.g., text, audio and/or video stream, images, etc.) into structured data (e.g., patient record). The resulting structured data may be communicated via a network to remotely-located structured data sources.

The integration of multiple input data streams advantageously provides redundancy in information to strengthen or reject any hypothesis, diagnosis or determination, which may not be possible by using a single stream of data. For example, the physician may say “the ear looks red”. Such audio information may be captured and combined with an image captured by the otoscope as well as relevant data extracted from an external data source based on a clinical ontology. The combined data may then be converted to structured data to support the hypothesis that the patient has an ear infection. The clinical ontology provides additional evidence that allows inference engine to determine that the derived structured result of erythema of the tympanic membrane (Systematized Nomenclature of Medicine or SNOMED code 300153005), fluid behind the membrane (SNOMED code 164241003) and acute otitis media of the left ear (SNOMED code 194288009) are valid options, thereby eliminating less probable inferences. This advantageously allows the hypothesis to be ontology-driven or ontology-guided, and to be supported by both image processing as well speech recognition, which is much stronger than a hypothesis that relies only on one type of input data.

While the description herein is generally drawn to the medical field, namely, EHRs, the present framework may be used in other industries to unobtrusively capture and assimilate information as it is naturally produced during the normal course of business. For instance, the present framework may be applied in a laboratory where science and engineering activities are performed. The framework may capture, translate and make determinations based on what is captured, how it is captured, when it is captured, etc. For example, the framework can capture the way an engineer is working on a system, where the system is positioned, what the engineer says about the system, etc., assimilate that information and then make a determination (based on probabilities, for example) about the state of the system that the engineer is working on. It may also be used to capture information while service professionals are servicing equipment (e.g., engines, medical devices, etc.) at a site.

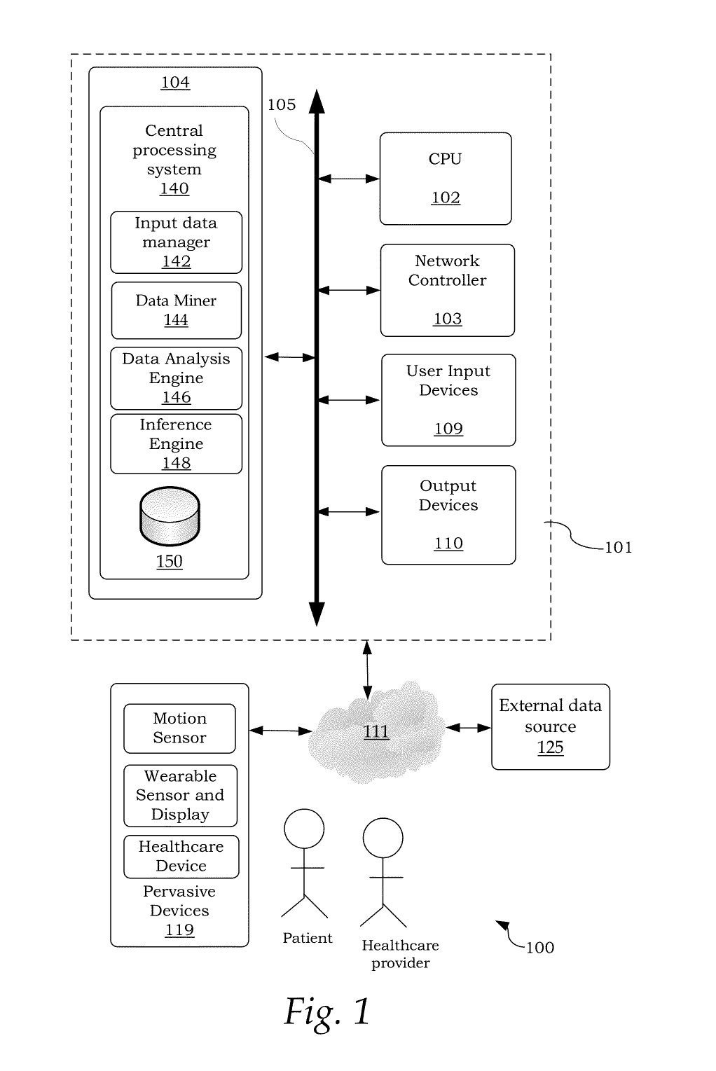

FIG. 1 shows an exemplary architecture 100 for implementing a method and system of the present disclosure. The computer system 101 may include, inter alia, a processor such as a central processing unit (CPU) 102, a non-transitory computer-readable media 104, a network controller 103, an internal bus 105, one or more user input devices 109 (e.g., keyboard, mouse, touch screen, etc.) and one or more output devices 110 (e.g., printer, monitor, external storage device, etc.). Computer system 101 may further include support circuits such as a cache, a power supply, clock circuits and a communications bus. Computer system 101 may take the form of hardware, software, or may combine aspects of hardware and software. Although computer system 101 is represented by a single computing device in FIG. 1 for purposes of illustration, the operation of computer system 101 may be distributed among a plurality of computing devices. For example, it should be appreciated that various subsystems (or portions of subsystems) of computer system 101 may operate on different computing devices. In some such implementations, the various subsystems of the system 101 may communicate over network 111.

The network 111 may be any type of communication scheme that allows devices to exchange data. For example, the network 111 may include fiber optic, wired, and/or wireless communication capability in any of a plurality of protocols, such as TCP/IP, Ethernet, WAP, IEEE 802.11, or any other protocols. Implementations are contemplated in which the system 100 may be accessible through a shared public infrastructure (e.g., Internet), an extranet, an intranet, a virtual private network (“VPN”), a local area network (LAN), a wide area network (WAN), P2P, a wireless communications network, telephone network, facsimile network, cloud network or any combination thereof.

Computer system 101 may communicate with various external components via the network 111. In some implementations, computer system 101 is communicatively coupled to multiple networked pervasive (or ubiquitous) computing devices 119. Pervasive devices 119 generally refer to those devices that “exist everywhere”, and are completely connected and capable of acquiring and communicating information unobtrusively, substantially continuously and in real-time. Data from pervasive devices 119 within, for example, a defined geographic region (e.g., patient examination room, healthcare facility, etc.), can be monitored and analyzed by, for example, central processing system 140 of computer system 101, to translate into structured data and to make substantially real-time inferences regarding, for example, a patient's state.

Pervasive devices 119 may include unstructured or semi-structured data sources that provide, for instance, images, waveforms or textual documents, as well as structured data sources that provide, for instance, position sensor data, motion sensor data or measurement data. In some implementations, multiple pervasive devices 119 are provided for collecting medical data during examination, diagnosis and/or treatment of a patient.

An exemplary pervasive device 119 includes a motion sensor that recognizes specific gestures (e.g., hand motions). Various methods may be used to track the movement of humans and objects in three-dimensional (3D) space. In one example, the motion sensor includes an infrared laser projector combined with a monochrome complementary metal-oxide-semiconductor (CMOS) sensor, which captures video data in 3D space under ambient light conditions. The sensing range of the instrument may be adjustable. The instrument may be strategically positioned in, for instance, the healthcare provider's (e.g., physician's) office so that it can capture every relevant aspect of the patient examination. This may include, for example, capturing the healthcare provider's movements and/or positioning, as well as the patient's movement and/or positioning.

Another exemplary pervasive device 119 includes a wearable sensor and display, such as a wearable computer integrated with a front facing video camera and an optical head-mounted display (e.g., Google Glass). Such wearable sensor and display may be combined with substantially real-time video processing to enhance the healthcare provider's workflow and improve patient safety through, for instance, error checking or other feedback during workflows. In some implementations, the video processing is performed by the central processing system 140. It may also be performed by the wearable computer itself, or any other system. Video processing may be performed to parse out medical information for processing and storage as structured data within, for example, external data source 125. Central processing system 140 may serve to register the wearable sensor and display for use within the healthcare facility (e.g., hospital), handle communications with other systems, and provide the location of the wearable sensor and display within the facility via, for example, global positioning system (GPS), radio frequency identification (RFID) or any other positioning systems.

Other exemplary pervasive devices 119 include instruments used by a healthcare provider during the normal course of examining, diagnosing and/or treating a patient. Such healthcare devices include, but are not limited to, cameras, facial recognition systems and devices, voice recognition systems and devices, audio recording devices, dictation devices, blood pressure monitors, heart rate monitors, medical instruments (e.g., endoscopes, otoscopes, anoscopes, sigmoidoscopes, rhinolaryngoscopes, laryngoscopes, colposcopes, gastroscopes, colonoscopies, etc.), and the like.

It should be understood that the aforementioned exemplary pervasive devices 119 may include any necessary software to read and interpret data (e.g., images, movement, sound, etc.). These pervasive devices 119 may collect or acquire data from the healthcare provider (e.g., physician) and/or from the patient. For example, a dictation device or microphone may be placed near, proximate or adjacent to the patient's mouth and/or the healthcare provider's mouth so as to capture words, sounds, etc., of the provider and the patient.

In some implementations, computer system 100 is communicatively coupled to one or more external data sources 125. External data source 125 may include, for example, a repository of patient records. The patient records may also be locally stored on database 150. Patient records may be computer-based patient records (CPRs), electronic medical records (EMRs), electronic health records (EHRs), personal health records (PHRs), and the like. External data source 125 may be implemented on one or more additional computer systems or storage devices. For example, external data source 125 may include a data warehouse system residing on a separate computer system, a picture archiving and communication system (PACS), or any other now known or later developed hospital, medical institution, medical office, testing facility, pharmacy or other medical patient record storage system.

The present technology may be implemented in various forms of hardware, software, firmware, special purpose processors, or a combination thereof, either as part of the microinstruction code or as part of an application program or software product, or a combination thereof, which is executed via the operating system. In some implementations, the techniques described herein may be implemented as computer-readable program code tangibly embodied in non-transitory computer-readable media 104. Non-transitory computer-readable media 104 may include one or more memory storage devices such as random access memory (RAM), read only memory (ROM), magnetic floppy disk, flash memory, other types of memories, or a combination thereof.

The present techniques may be implemented by central processing system 140 stored in computer-readable media 104. In some implementations, central processing system 140 serves to facilitate temporal integration of multiple data streams (e.g., data arising from physical interaction between a healthcare provider and a patient). The system 140 may capture structured clinical data based on inferences derived from such temporal integration. The techniques are advantageously minimally invasive, since the healthcare provider spends more effort in providing care (e.g., examination, diagnoses, treatment, etc.) than documenting the process.

Central processing system 140 may include input data manager 142, data miner 144, data analysis engine 146, inference engine 148 and database 150. These exemplary components may operate to assimilate data, transform the data into structured data, make determinations based on the structured data and/or transfer the structured data to, for instance, remotely-located structured sources via, for instance, network 111. It should be understood that less or additional components may be included in the central processing system 140, and the central processing system 140 is not necessarily implemented in a single computer system.

Database 150 may include, for instance, a domain knowledge base. Information stored in the domain knowledge base may be provided as, for example, encoded input to the system 140, or by programs that produce information that can be understood by the system 140. The domain knowledge base may include, for example, domain-specific criteria that facilitate the assimilation of data (e.g., mining, interpreting, structuring, etc.) from various data sources (e.g., unstructured sources). Domain-specific criteria may include organization-specific domain knowledge. For example, such criteria may include information about the data available at a particular hospital, document structures at the hospital, policies and/or guidelines of the hospital, and so forth. Domain-specific criteria may also include disease-specific domain knowledge. For example, the disease-specific domain knowledge may include various factors that influence risk of a disease, disease progression information, complications information, outcomes and variables related to a disease, measurements related to a disease, policies and guidelines established by medical bodies, etc.

Central processing system 140 may automatically assimilate medical information generated during the performance of a regular healthcare task (e.g., examination) without requiring “extra” effort on the part of the healthcare provider to record the information. In other words, the healthcare provider can provide normal and appropriate care with minimal extra effort in recording the medical data. If necessary, the medical data is then automatically transformed into structured format (e.g., results of tests, summaries of visits, symptoms etc.). In some implementations, the system 140 automatically and continuously captures the relevant information during, between and after a patient encounter. In other words, the system 140 captures all relevant data generated during the healthcare provider's normal performance in, for example, examining, diagnosing and/or treating the patient. These and other exemplary features and advantages will be described in more detail in the following description.

The computer system 100 may be a general purpose computer system that becomes a specific purpose computer system when executing the computer-readable program code. It is to be understood that, because some of the constituent system components and method steps depicted in the accompanying figures can be implemented in software, the actual connections between the systems components (or the process steps) may differ depending upon the manner in which the present framework is programmed. For example, the system 100 may be implemented in a client-server, peer-to-peer (P2P) or master/slave configuration. Given the teachings of the present disclosure provided herein, one of ordinary skill in the related art will be able to contemplate these and similar implementations or configurations of the present invention.

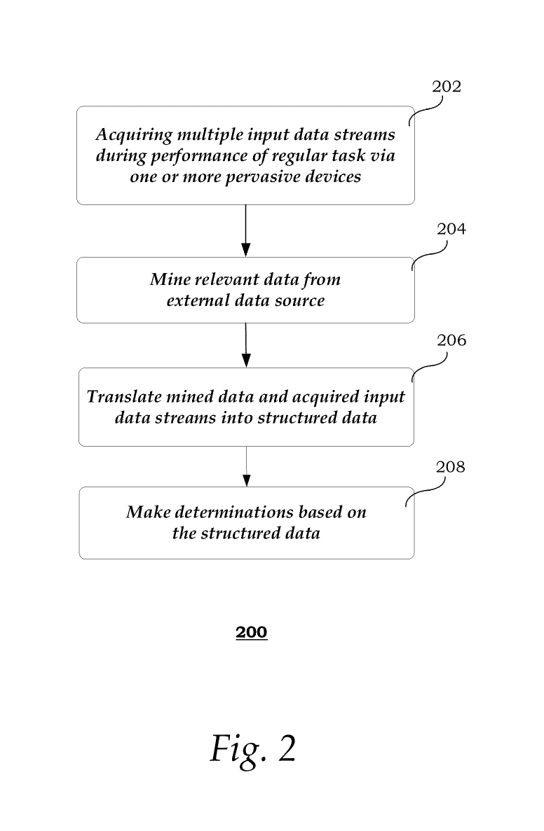

FIG. 2 shows an exemplary method 200 of integrating multiple data streams. The steps of the method 200 may be performed in the order shown or a different order. Additional, different, or fewer steps may be provided. Further, the method 200 may be implemented with the system 100 of FIG. 1, a different system, or a combination thereof.

At 202, multiple input data streams are acquired by one or more pervasive devices 119 during performance of a regular task. A “regular task” generally refers to a procedure that is undertaken during the normal course of business, and not for the sole purpose of recording structured data. In the context of a healthcare setting, exemplary regular tasks may be performed to examine, diagnose and/or treat a patient. Pervasive devices 119 may be strategically placed on or near, for example, the patient and/or healthcare provider, to automatically capture relevant data generated during, for instance, a patient's encounter with the healthcare provider. The captured data may include, but is not limited to, 3D gestural input, speech recognition output followed by information extraction, image analysis, touch input, location awareness, biometric authentication (by, for example, ensemble methods), etc. The captured data may further include indications of time (e.g., time stamps) at which the data was acquired.

For example, the pervasive devices 119 may capture information from the healthcare provider, such as where his or her hand is placed relative to the pervasive device location with respect to the patient's body, where the healthcare provider is positioned relative to the patient, how the healthcare provider moves relative to the patient, what the healthcare provider says to the patient, another provider or anyone else present. The pervasive devices 119 may also capture information from the patient, such as whether the patient is sitting or standing, bent over, laying down, etc., what the patient says to the provider (e.g., symptoms, complaints, etc.), how the patient communicates (e.g., does he or she sound “hoarse” or is he or she having trouble speaking, does the patient say “ahh”?). The pervasive devices 119 may also capture notes taken by either the provider or the patient, where these notes may be hand-written, typed, coded, etc.

The pervasive device 119 may be, for example, a healthcare device equipped with a sensor (e.g., camera) for collecting information associated with a patient examination. The sensor may capture one or more images of the healthcare provider examining a portion of the patient's body, such as a knee, leg, arm, ear, etc. Those images are generally unstructured data that the system 140 may then translate to structured data. Such data may further be combined with other structured and/or unstructured data. For example, it may be combined with structured patient data, such as medical history, data mining of the record, etc., and/or ontologies, to make determinations regarding the patient. Such data may also be used along with information captured by a camera on a scope. For instance, the first set of data may include an overall 3D image of the healthcare provider examining near the patient's ear. The second set of image data may be generated from a camera on a wireless enabled otoscope. The third set of data may include an audio recording of the healthcare provider's statements—“examining the left ear” or “fluid in the ear”. The first, second and third sets of data may all be translated to structured data for further analysis. The physical evidence provided by the first and second sets of data provides additional support for the text generated from the third set of data, and allows for more accurate use of the information than just using the text alone.

In some implementations, the input data manager 142 pre-processes the captured data streams to protect the privacy of the healthcare provider and/or patient. For instance, the input data manger 142 may distort (e.g., make blur) or obscure the patient's face or voice (or any identifying features) and/or patient's personal information (e.g., name, social security number, birth date, account number, etc.). In some implementations, the input data manager 142 encodes the captured data before passing it to, for instance, the data analysis engine 146 to prevent unauthorized persons from accessing it.

At 204, data miner 144 collects relevant data from external data source 125. Data miner 144 may include an extraction component for mining information from electronic patient records retrieved from, for example, external data source 125. Data miner 144 may combine available evidence in a principled fashion over time, and draw inferences from the combination process. The mined information may be stored in a structured database (e.g., database 150), or communicated to other systems for subsequent use.

In some implementations, the extraction component employs domain-specific criteria to extract the information. The domain-specific criteria may be retrieved from, for example, database 150. In some implementations, the extraction component is configured to identify concepts in free text treatment notes using, for instance, phrase extraction. Phrase extraction (or phrase spotting) may be performed by using a set of rules that specify phrases of interest and the inferences that can be drawn therefrom. Other natural language processing or natural language understanding methods may also be used instead of, or in conjunction with, phrase extraction to extract data from free text. For instance, heuristics and/or machine learning techniques may be employed to interpret unstructured data.

In some implementations, the extraction component employs a clinical ontology (e.g., Systematized Nomenclature of Medicine or SNOMED) to extract the information. The clinical ontology constrains the probable data options, which reduces the time and costs incurred in assimilating structured data. Use of clinical ontologies for mining and decision support is described in, for example, U.S. Pat. No. 7,840,512, which is incorporated by reference in its entirety herein. It describes a domain knowledge base being created from medical ontologies, such as a list of disease-associated terms.

As an example, the healthcare provider may not verbally describe the appearance of the tympanic membrane but simply state that it looks like the patient has an “ear infection”, which can be combined with the results of the image analysis. To limit the choices, the ontology provides additional evidence which allows the inference engine to determine that the derived structured result of erythema of the tympanic membrane (SNOMED code 300153005), fluid behind the membrane (SNOMED code 164241003) and acute otitis media of the left ear (SNOMED code 194288009) are valid options, thereby eliminating less probable inferences. In addition, the structured information can be encoded using the ontologies for better interoperability. This will avoid situations where often even structured data can be understood differently by different healthcare providers.

In some implementations, a clinical ontology is used to mine patient records. A probabilistic model may be trained using the relationships between different terms with respect to a disease. The medical data from a patient record may also include historical information, such as the patient's medical history (e.g., previous infections, diseases, allergies, surgeries, etc.), and may also include personal information about the patient, such as date of birth, occupation, hobbies, etc. The domain knowledge base may contain domain-specific criteria that relates to a condition of interest, billing information, institution-specific knowledge, etc. In addition, the domain-specific criteria may be specific to cancer, lung cancer, set of symptoms, whether the patient is a smoker, etc.

The system 140 may search, mine, extrapolate, combine, etc. input data that is in an unstructured format. In some implementations, domain knowledge base 150 stores a list of disease-associated terms or other medical terms (or concepts). Data miner 144 may mine for corresponding information from a medical record based on, for example, probabilistic modeling and reasoning. For instance, for a medical concept such as “heart failure,” data miner 144 may automatically determine the odds that heart failure has indeed occurred, or not occurred, in the particular patient based on a transcribed text passage from, for example, a pervasive device 119. In this example, the concept is “heart failure” and the states are “occurred” and “not occurred.”

At 206, data analysis engine 146 automatically combines and translates the acquired data from the input data manager 142 and optionally, mined data from the data miner 144, into structured data. Data analysis engine 146 may automatically convert unstructured or semi-structured data into a structured format. If the data is originally unstructured information (e.g., “free-text” output of speech recognition), it may be converted into structured data using various techniques, such as Natural Language Processing (NLP), NLP using machine learning, NLP using neural networks, image translation and processing, etc. Alternatively, if the data is already structured or suitable for a structured format, it may be inserted into fields of a structured format. Once the data is translated into a structured format, it can be more easily manipulated, used, analyzed, processed, etc.

At 208, one or more determinations may be made based on the structured data. In some implementations, inference engine 148 makes one or more inferences regarding the patient's current state (e.g., whether patient has cancer). Other types of determinations may also be made. For example, data analysis engine 146 may predict future states, identify patient populations, generate performance measurement information (e.g., quality metric reporting), create and manage workflows, perform prognosis modeling, predict and prevent risks to patients (e.g., falls, re-admissions, etc.), provide customer on-line access to structured clinical data in the collection, and so forth.

As discussed previously, multiple data streams may be combined. For example, data providing information about how the healthcare provider and patient are physically interacting (e.g. healthcare provider's right hand is near patient's left ear at the moment captured by a camera) may be combined with data from a speech recognition engine (e.g. healthcare giver mentions “looking or examining your ears”) and data from a healthcare device (e.g. a wireless enabled otoscope which streams images). The data may also be optionally augmented by historical data about the patient for better inference. By relying on the temporal confluence of these multiple data elements and the conceptual relationships therebetween, the inference engine 148 may determine, for example, that the image received from the healthcare device (e.g., otoscope) is from the patient's left ear. The image from the healthcare device may then be automatically analyzed by specialized image processing software (such as computer-aided diagnosis or CAD) to determine, for instance, that there is erythema and fluid behind the tympanic membrane. This determination may be combined with, for example, the elevated body temperature provided by, for instance, assessing brightness of an infrared body image or a body thermometer transmitting data (e.g., wirelessly) to the system 140 via some interface. Having access to the patient's age and reason for the visit (“tugging at ears”) from the mined patient record allows the inference engine 148 to make an inference that the patient is experiencing an episode of acute otitis media.

One exemplary method of making determinations regarding patient states is as follows. Once the unstructured information is extracted from the medical records, it is stored into a data structure, such as a database or spreadsheet. The inference engine 148 may then assign “values” to the information. These “values” may be labels, as described in U.S. Pat. No. 7,840,511, which is herein incorporated by reference. In some implementations, labeled text passages from the medical data are mapped to one or more medical concepts. Exemplary medical concepts include, but are not limited to, “Congestive Heart Failure”, “Cardiomyopathy”, “Any Intervention”, and so forth. The outcome of this analysis may be at, for instance, a sentence, paragraph, document, or patient file level. For instance, the probability that a document indicates that the medical concept is satisfied (“True”) or not (“False”) may be modeled. The model may be based on one level (e.g., sentence) for determining a state at a higher or more comprehensive level (e.g., paragraph, document, or patient record). The state space may be Boolean (e.g., true or false) or any other discrete set of three or more options (e.g., large, medium and small). Boolean states spaces may be augmented with the neutral state (herein referred to as the “Unknown” state).

Inference engine 148 may include a probabilistic model that assigns labels to data in the medical records. The labels for the concepts may be compared to determine if there is any inconsistent or duplicate information. For example, if a patient has indicated in a questionnaire that he or she is not a smoker, the inference engine 148 may generate a label showing “smoker=no”. However, if a healthcare provider has noted in his or her notes that the person is a smoker, in another part of the records it may show a label “smoker=yes”. This situation may arise when, for instance, the patient has recently quit smoking. Since these labels conflict, the probabilistic model may identify and report this anomaly. The inference engine 148 may also identify and report duplicate information. For example, it may indicate that two instances indicated “smoker=no”.

As another example, consider the situation where a statement such as “The patient has metastatic cancer” is found in a healthcare provider's notes, and the inference engine 148 may conclude from that statement that <cancer=True (probability=0.9)>. This is equivalent to asserting that <cancer=True (probability=0.9), cancer=unknown (probability=0.1)>. Now, further assume that there is a base probability of cancer <cancer=True (probability=0.35), cancer=False (probability=0.65)> (e.g., 35% of patients have cancer). This assertion may then be combined with the base probability of cancer to obtain, for example, the assertion <cancer=True (probability=0.93), cancer=False (probability=0.07)>. However, there may be conflicting evidence. For example, another record, or the same record, may state that the patient does not have cancer. Here, we may have, for example, <cancer=False (probability=0.7). The inference engine 148 may identify this instance and report it to a user.

In some implementations, data analysis engine 146 manages a workflow by providing feedback information based on structured data generated from sensor data captured by a wearable sensor and display 119. The wearable sensor and display may be worn by a healthcare provider during a patient encounter. Substantially real-time video processing and feedback generation may be provided in association with one or more steps undertaken in the workflow. The workflow may be associated with a healthcare task or procedure regularly performed by a healthcare provider (e.g., nurse, physician, clinician, etc.) during the normal course of business.

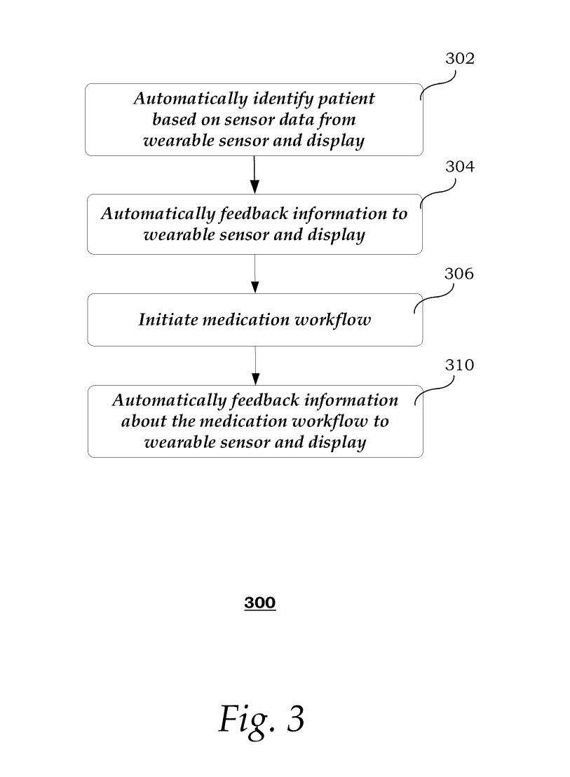

FIGS. 3-6 illustrate exemplary workflows including medication administration error checking, device to patient association, patient collection labeling and patient privacy protection respectively. It should be appreciated that the following methods 300, 400, 500 and 600 may be initiated when a healthcare provider (e.g., nurse, physician, clinician, etc.) enters a patient's room. The healthcare provider may be wearing a wearable sensor and display 119, such as a wearable computer with a front-facing video camera and an optical head-mounted display (e.g., Google Glass). As the healthcare provider looks at, and therefore directs the sensor towards, the patient, the wearable sensor and display 119 automatically acquires data (e.g., image, sound and/or video data) of the patient and/or the surrounding environment. In the following steps, the acquired sensor data may be translated into structured data (e.g., fields containing information associated with recognized healthcare devices, events, locations, third parties, time stamps, etc.) and stored in the patient record for future retrieval (e.g., for audit purposes).

Turning to FIG. 3, an exemplary method 300 for facilitating a medication workflow is illustrated. In some implementations, exemplary method 300 provides a mechanism to automatically pre-populate a medication order based at least in part on sensor data. Additionally, or alternatively, exemplary method 300 provides an error checking mechanism to facilitate medication administration. Several levels of integration may be used to achieve multiple levels of error checking. It should be appreciated that the steps of the method 300 may be performed in the order shown or a different order. Additional, different, or fewer steps may be provided. Further, the method 300 may be implemented with the system 100 of FIG. 1, a different system, or a combination thereof.

At 302, data analysis engine 146 receives the sensor data (e.g., image, sound and/or video data) acquired by wearable sensor and display 119, and automatically identifies the patient based on the sensor data of the patient. In some implementations, data analysis engine 146 performs a facial recognition algorithm to identify the patient based on one or more images in the sensor data. Data analysis engine 146 may also identify the patient by recognizing a barcode or any other optical machine-readable representation of data. The barcode may be located on, for instance, a wrist band or badge worn by the patient. By using a wearable sensor and display 119 to recognize the barcode, the need to carry a cumbersome handheld barcode scanner to manually scan the barcode is advantageously eliminated. Other methods of identifying the patient, such as using a global positioning system (GPS) or any other positioning system, may also be used.

At 304, in response to the patient identification, data analysis engine 146 automatically feedbacks information to be presented by the wearable sensor and display 119. If the patient cannot be identified or is not the same patient to be expected at the physical location of the wearable sensor and display 119 (i.e., wrong patient may be in the room), a warning notification may be presented (e.g., displayed) by the wearable sensor and display 119 to notify the healthcare provider of the error encountered in the patient identification. If the patient can be identified and/or the patient is expected to be at the same physical location of the wearable sensor and display 119, relevant information associated with the identified patient (e.g., demographic data, clinical summary, alerts, worklist items, etc.) may be presented by the wearable sensor and display 119.

At 306, the data analysis engine 146 initiates a medication workflow. The medication workflow may be a medication order workflow and/or a medication administration workflow. The medication workflow may be initiated in response to receiving sensor data while the healthcare provider looks at, and therefore directs the wearable sensor and display 119 towards, the medication. The medication workflow may be retrieved from, for example, database 150.

At 310, data analysis engine 146 automatically feedbacks information associated with the medication workflow to the wearable sensor and display 119. In some implementations, the medication workflow is a medication order workflow. Data analysis engine 146 may automatically recognize order-related information based on the sensor data from the wearable sensor and display 119, and use such information to pre-populate a medication order. For example, in an ear infection case, the physician may say to the patient “I will put you on antibiotics for this.” The microphone in the wearable sensor and display 119 may capture the audio data, and a speech processing unit may convert such audio data to text data. Data analysis engine 146 may then combine the text data with other information, such as the patient's age, weight, gender, and the fact that “ear infection” was a problem that has been established earlier to automatically pre-populate an evidence-based medication order. The medication order may prescribe, for example, a standard dose (e.g., 500 mg Augmentin PO q12 h×5 days) for patients of this age for an ear infection. The pre-populated medication order may be displayed on the wearable sensor and display 119 to enable the physician to verify and correct the prescription if desired.

In some implementations, the medication workflow is a medication administration workflow. Data analysis engine 146 may automatically identify the medication based on the sensor data of the medication from the wearable sensor and display 119. Data analysis engine 146 may perform a recognition algorithm to automatically identify the medication based on, for instance, the shape, color, packaging or other features in one or more images from the sensor data. Data analysis engine 146 may also identify the medication by recognizing a barcode or any other optical machine-readable representation of data. The barcode may be located on, for instance, a container of the medication. Other methods of identifying the medication may also be used.

If the medication cannot be recognized or does not match the prescription for the patient (e.g., wrong dosage or medication), a warning notification may be presented (e.g., displayed) on the wearable sensor and display 119 to notify the healthcare provider of the error encountered in the medication identification. If the medication can be identified and/or matches the prescription, a confirmation message may be presented by the wearable sensor and display 119 to instruct the healthcare provider to continue with the medication administration.

Data analysis engine 146 may automatically recognize, based on the sensor data, the occurrence of the event that the medication has been administered to the patient. The sensor data may be acquired as the healthcare provider witnesses, and therefore directs the wearable sensor and display 119 towards, the patient during the medication administration. The medication may be administered by, for example, intravenous (IV) infusion, IV push or oral ingestion.

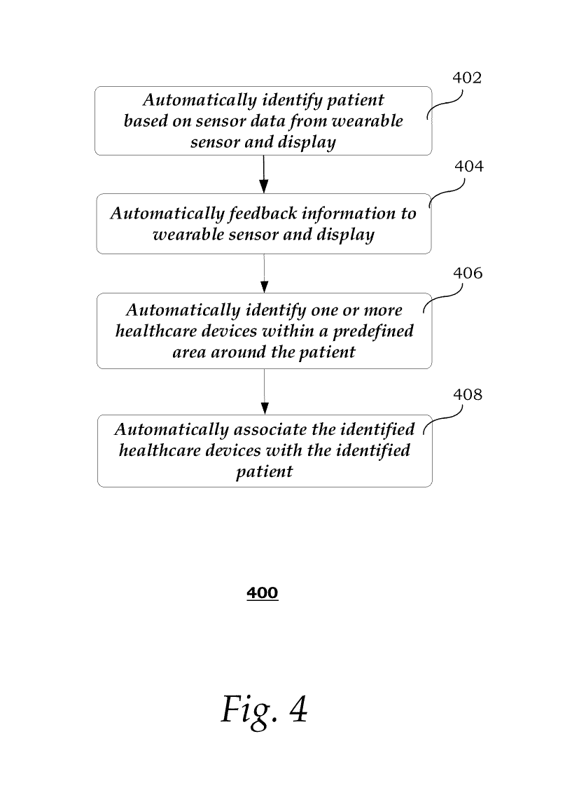

FIG. 4 illustrates an exemplary method 400 for automatically associating one or more healthcare devices with a particular patient. The method 400 provides an automatic mechanism to associate healthcare devices within a vicinity of a patient with the patient. Traditionally, as these healthcare devices are typically moved around frequently even throughout the patient's stay, the device is manually associated with the patient by selecting or entering the patient identifier (ID) at the healthcare device. By using the method 400, a more passive workflow may be employed. It should be appreciated that the steps of the method 400 may be performed in the order shown or a different order. Additional, different, or fewer steps may be provided. Further, the method 400 may be implemented with the system 100 of FIG. 1, a different system, or a combination thereof.

At 402, data analysis engine 146 receives the sensor data acquired by the wearable sensor and display 119 as the healthcare provider looks at the patient, and automatically identifies the patient based on such sensor data. In some implementations, data analysis engine 146 performs a facial recognition algorithm to identify the patient based on one or more images in the sensor data. Data analysis engine 146 may also identify the patient by recognizing a barcode or any other optical machine-readable representation of data. The barcode may be located on, for instance, a wrist band or badge worn by the patient. By using a wearable sensor and display to recognize the barcode, the need to carry a cumbersome handheld barcode scanner to manually scan the barcode is advantageously eliminated. Other methods of identifying the patient, such as using a global positioning system (GPS) or any other positioning system, may also be used.

At 404, in response to the patient identification, data analysis engine 146 automatically feedbacks information to be presented by the wearable sensor and display 119. If the patient cannot be identified or is not the same patient to be expected at the physical location of the wearable sensor and display 119 (i.e., wrong patient may be in the room), a warning notification may be presented (e.g., displayed) by the wearable sensor and display 119 to notify the healthcare provider. If the patient can be identified and/or the patient is expected to be at the same physical location of the wearable sensor and display 119, relevant information associated with the identified patient (e.g., demographic data, clinical summary, alerts, worklist items, etc.) may be presented by the wearable sensor and display 119.

At 406, data analysis engine 146 automatically identifies one or more healthcare devices within a predefined area around the patient. The predefined area may be, for instance, the room in which the patient is located. The healthcare devices may be any devices used to, for example, collect or display data associated with the patient or to deliver healthcare to the patient. Exemplary healthcare devices include, but are not limited to, infusion pump devices, patient monitoring devices, electrocardiogram (ECG) or intracardiac electrogram (ICEG) devices, imaging devices, ventilators, breathing devices, drip feed devices, transfusion devices, and so forth. These healthcare devices are generally mobile and coupled wirelessly to the system 101 or any other information system (e.g., health information system).

In some implementations, data analysis engine 146 performs a shape recognition algorithm to passively identify the healthcare devices based on one or more images in the sensor data. The recognition algorithm may, for instance, recognize the actual physical connection of the patient to the healthcare device (e.g., IV tubes, ventilator pipes, electrocardiography (EKG) leads, etc.) and identify the type of device from a set of known devices. Data analysis engine 146 may also identify the healthcare devices by recognizing a barcode, identifier (ID) or any other optical machine-readable representation of data. The barcode may be located on, for instance, the healthcare device. One exemplary method of recognizing healthcare devices is described in U.S. Pat. No. 8,565,500, which is herein incorporated by reference. Other methods of identifying the healthcare devices may also be used. In response to the identification, an identifier that uniquely identifies the healthcare device may be determined.

At 408, in response to the device identification, data analysis engine 146 automatically associates the identified healthcare devices with the identified patient. Such association may be performed by associating the healthcare device identifier with data identifying the patient (e.g., patient name, identifier number, etc.). Data analysis engine 146 may communicate the healthcare device identifier and the patient identification data to, for instance, ancillary devices. Ancillary devices include other connected devices (pervasive or non-pervasive) that may use this identifying information. Examples of ancillary devices include medication administration devices, vital signal monitoring machines, associated cameras that are able to check for falls by a patient known to be at risk of falls, and so forth.

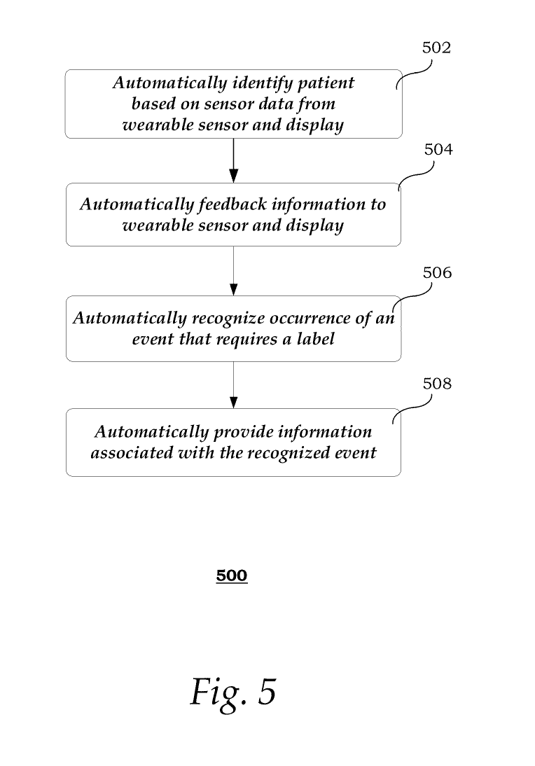

FIG. 5 illustrates an exemplary method 500 for facilitating labeling of items collected from a patient in a healthcare setting. It should be appreciated that the steps of the method 500 may be performed in the order shown or a different order. Additional, different, or fewer steps may be provided. Further, the method 500 may be implemented with the system 100 of FIG. 1, a different system, or a combination thereof.

At 502, data analysis engine 146 receives the sensor data acquired by the wearable sensor and display 119, and automatically identifies the patient based on the sensor data of the patient. In some implementations, data analysis engine 146 performs a facial recognition algorithm to identify the patient based on one or more images in the sensor data. Data analysis engine 146 may also identify the patient by recognizing a barcode or any other optical machine-readable representation of data. The barcode may be located on, for instance, a wrist band or badge worn by the patient. By using a wearable sensor and display that recognizes the barcode, the need to carry a cumbersome handheld barcode scanner to manually scan the barcode is advantageously eliminated. Other methods of identifying the patient, such as using a global positioning system (GPS) or any other positioning system, may also be used.

At 504, in response to the patient identification, data analysis engine 146 automatically feedbacks information to be presented by the wearable sensor and display 119. If the patient cannot be identified or is not the same patient to be expected at the physical location of the wearable sensor and display 119 (i.e., wrong patient may be in the room), a warning notification may be presented (e.g., displayed) by the wearable sensor and display 119 to notify the healthcare provider. If the patient can be identified and/or the patient is expected to be at the same physical location of the wearable sensor and display 119, relevant information associated with the identified patient (e.g., demographic data, clinical summary, alerts, worklist items, etc.) may be presented by the wearable sensor and display 119.

At 506, data analysis engine 146 automatically recognizes occurrence of an event that requires a label. In some implementations, such event involves the collection of one or more physical items from a patient in a healthcare setting. These physical items may include, but are not limited to, printed document (e.g., X-ray image), biological specimens (e.g., blood, urine, milk, etc.) and so forth. These items need to be labeled and marked with an identifier that uniquely identifies the originating patient to prevent matching them with the wrong patient (i.e. other than the originating patient).

In accordance with some implementations, the data analysis engine 146 receives one or more images in the sensor data of the patient and the surrounding environment as the healthcare provider collects the item from the patient (e.g., draws blood from the patient's wrist). Based on the one or more images, the data analysis engine 146 may passively recognize the occurrence of the event involving the collection of the physical item from the patient. A shape recognition algorithm or any other algorithm may be used to automatically recognize such event.

At 508, in response to the recognition of the occurrence of the event, data analysis engine 146 automatically provides information associated with the recognized event to the wearable sensor and display 119. The wearable sensor and display 119 may then present (e.g., display) a message that alerts the healthcare provider that a label is required. A user selectable option may be presented to enable the healthcare provider to request for the label to be printed. The label may be printed at, for example, a nearby printer. The label may include, for instance, a barcode or any other machine readable representation of the patient identifier (e.g., name, date of birth, identification number, etc.) that uniquely identifies the originating patient.

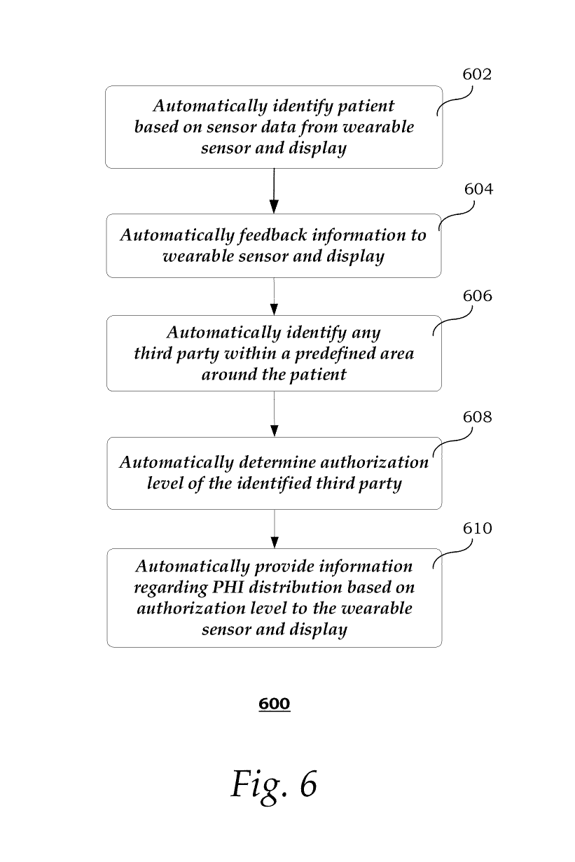

FIG. 6 illustrates an exemplary method 600 for facilitating patient privacy protection. Protection of patient healthcare information (PHI) is commonly a major concern. With many people coming in and out of hospitals on a regular basis, PHI may be accessed by unauthorized parties. The method 600 advantageously mitigates such risks of exposure. It should be appreciated that the steps of the method 600 may be performed in the order shown or a different order. Additional, different, or fewer steps may be provided. Further, the method 600 may be implemented with the system 100 of FIG. 1, a different system, or a combination thereof.

At 602, data analysis engine 146 receives the sensor data acquired by the wearable sensor and display 119, and automatically identifies the patient based on the sensor data of the patient. In some implementations, data analysis engine 146 performs a facial recognition algorithm to identify the patient based on one or more images in the sensor data. Data analysis engine 146 may also identify the patient by recognizing a barcode or any other optical machine-readable representation of data. The barcode may be located on, for instance, a wrist band or badge worn by the patient. By using a wearable sensor and display to recognize the barcode, the need to carry a cumbersome handheld barcode scanner to manually scan the barcode is advantageously eliminated. Other methods of identifying the patient, such as using a global positioning system (GPS) or any other positioning system, may also be used.

At 604, in response to the patient identification, data analysis engine 146 automatically feedbacks information to be presented by the wearable sensor and display 119. If the patient cannot be identified or is not the same patient to be expected at the physical location of the wearable sensor and display 119 (i.e., wrong patient may be in the room), a warning notification may be presented (e.g., displayed) by the wearable sensor and display 119 to notify the healthcare provider. If the patient can be identified and/or the patient is expected to be at the same physical location of the wearable sensor and display 119, relevant information associated with the identified patient (e.g., demographic data, clinical summary, alerts, worklist items, etc.) may be presented by the wearable sensor and display 119.

At 606, data analysis engine 146 automatically identifies any third party within a predefined area around the patient. The predefined area may be, for instance, the room in which the patient is located. The third party may be any person other than the patient and the healthcare provider. In some implementations, data analysis engine 146 performs a facial recognition algorithm to passively identify the third party based on one or more images in the sensor data. In response to the identification, an identifier that uniquely identifies the third party may be determined.

At 608, data analysis engine 146 automatically determines the authorization level of the identified third party. In some implementations, data analysis engine 146 may retrieve the authorization list associated with the patient to determine the authorization level of the identified third party. The authorization list may be retrieved from, for example, database 150 or any external data source 125. The authorization list may include identification data of one or more parties authorized to access at least some or all of the patient's PHI. For example, a spouse or child caregiver may be listed as authorized parties on the authorization list. If the identified third party is not on the authorization list, the authorization level of the identified third party is determined to be the lowest (i.e. unauthorized).

At 610, data analysis engine 146 automatically provides to the wearable sensor and display 119 information pertaining to PHI distribution based on the determined authorization level. Such information may be presented by the wearable sensor and display 119 to notify the healthcare provider. For example, if the recognized third party is determined to be authorized to receive the PHI, the wearable sensor and display 119 may present a notification indicating that the third party is authorized and it is safe to distribute the PHI. However, if the recognized third party is determined to be unauthorized to receive the PHI, the wearable sensor and display 119 may present a notification warning the healthcare provider that it is not safe to distribute the PHI. The wearable sensor and display 119 may also determine that the healthcare provider is speaking too loudly in the presence of unauthorized parties, and present a notification to remind the healthcare provider to speak more quietly into the microphone of the wearable sensor and display 119.

While the present invention has been described in detail with reference to exemplary embodiments, those skilled in the art will appreciate that various modifications and substitutions can be made thereto without departing from the spirit and scope of the invention as set forth in the appended claims. For example, elements and/or features of different exemplary embodiments may be combined with each other and/or substituted for each other within the scope of this disclosure and appended claims.

1. A system for integrating multiple input data streams, comprising:
a non-transitory memory device for storing computer readable program code; and
a processor in communication with the memory device, the processor being operative with the computer readable program code to:
acquire, from one or more pervasive devices, multiple input data streams during performance of a regular task;
translate the acquired input data streams into structured data; and
make one or more determinations based on the structured data.

2. The system of claim 1 wherein the multiple input data streams are acquired from a network of pervasive devices.

3. The system of claim 1 wherein the processor is further operative with the computer readable program code to pre-process the input data streams and protect privacy of a patient or a healthcare provider.

4. The system of claim 1 wherein the one or more pervasive devices comprise a healthcare device with a sensor.

5. The system of claim 4 wherein the unstructured data comprises image data, audio data, video data or a combination thereof.

6. The system of claim 1 wherein the processor is further operative with the computer readable program code to mine data from an external data source and combine the mined data with the acquired input data streams to generate the structured data.

7. The system of claim 6 wherein the processor is operative with the computer readable program code to mine the data from the external data source by using domain-specific criteria to mine the data from a patient record.

8. The system of claim 6 wherein the processor is operative with the computer readable program code to mine the data from the external data source by using a clinical ontology to mine the data from a patient record, wherein the clinical ontology constrains the one or more determinations.

9. The system of claim 8 wherein the clinical ontology comprises Systematized Nomenclature of Medicine.

10. The system of claim 1 wherein the processor is operative with the computer readable program code to translate the acquired input data into the structured data by using Natural Language Processing (NLP), machine learning, neural networks, image translation and processing, or a combination thereof.

11. The system of claim 1 wherein the processor is operative with the computer readable program code to translate the acquired input data into the structured data by inserting the acquired input data into fields of a structured format.

12. The system of claim 1 wherein the processor is operative with the computer readable program code to make the one or more determinations by making one or more inferences regarding a patient's current state.

13. The system of claim 1 wherein the processor is operative with the computer readable program code to make the one or more determinations by
assigning one or more values to the structured data, and
mapping the one or more values to one or more medical concepts.

14. The system of claim 1 wherein the one or more pervasive devices comprise a wearable sensor and display worn by a healthcare provider during a patient encounter.

15. The system of claim 14 wherein the processor is operative with the computer readable program code to make the one or more determinations by generating feedback information to manage a workflow.

16. The system of claim 14 wherein the processor is operative with the computer readable program code to generate the feedback information by
automatically identifying a patient based at least in part on sensor data from the wearable sensor and display, and
presenting, via the wearable sensor and display, the feedback information in response to the patient identification, wherein the feedback information indicates any error encountered in the patient identification.

17. The system of claim 14, wherein the processor is operative with the computer readable program code to generate the feedback information by
automatically identifying a medication based at least in part on sensor data from the wearable sensor and display, and
presenting, via the wearable sensor and display, the feedback information in response to the medication identification, wherein the feedback information indicates any error encountered in the medication identification.

18. The system of claim 14, wherein the processor is operative with the computer readable program code to generate the feedback information by
automatically pre-populating a medication order based at least in part on sensor data from the wearable sensor and display, and
presenting, via the wearable sensor and display, the medication order for verification.

19. The system of claim 14, wherein the processor is operative with the computer readable program code to generate the feedback information by
automatically recognizing, based on sensor data from the wearable sensor and display, occurrence of an event that requires a label, and
in response to recognizing the occurrence of the event, presenting, via the wearable sensor and display, the feedback information to alert the healthcare provider that a label is required.

20. The system of claim 14, wherein the processor is operative with the computer readable program code to generate the feedback information by
automatically identifying, based on sensor data from the wearable sensor and display, any third party within a predefined area around the patient,
determining an authorization level of the identified third party, and
presenting, via the wearable sensor and display, the feedback information pertaining to distribution of patient healthcare information based on the determined authorization level.

21. The system of claim 14 wherein the processor is operative with the computer readable program code to make the one or more determinations based on the structured data by
automatically identifying, based on sensor data from the wearable sensor and display, one or more healthcare devices within a predefined area around the patient,
determining identification data that uniquely identifies the one or more healthcare devices, and
automatically associating the identification data with the patient.

22. A non-transitory computer readable medium embodying a program of instructions executable by machine to perform steps for managing a healthcare workflow, the steps comprising:
receiving input sensor data from a wearable sensor and display worn by a healthcare provider during a patient encounter;
translating the input sensor data into structured data; and
providing, based on the structured data, feedback information in association with one or more steps undertaken in the healthcare workflow, wherein the feedback information is provided to the wearable sensor and display for presentation.

23. A method of managing a healthcare workflow, comprising:
receiving input sensor data from a wearable sensor and display worn by a healthcare provider during a patient encounter;
translating the input sensor data into structured data; and
providing, based on the structured data, feedback information in association with one or more steps undertaken in the healthcare workflow, wherein the feedback information is provided to the wearable sensor and display for presentation.
